(19) United States
(12) Patent Application Publication
(10) Pub. No.: US 2021/0067654 A1
(43) Pub. Date: Mar. 4, 2021

(54) WORKING COMPONENT START UP BASED ON USER INTENT

(71) Applicant: Hewlett-Packard Development Company, L.P., Spring, TX (US)

(72) Inventors: Donald J Fasen, Boise, ID (US); Brian C Mayer, Boise, ID (US)

(21) Appl. No.: 17/048,334

(22) PCT Filed: Aug. 8, 2018
(86) PCT No.: PCT/US2018/045760

§ 371 Date: Oct. 16, 2020

(51) Int. Cl. H04N 1/00; G06F 1/3234; G06F 1/3231

(52) U.S. Cl. CPC H04N 1/00896; H04N 1/00352; H04N 1/00411; H04N 1/00384; H04N 2201/0094; H04N 1/00037; G06F 1/3284; G06F 1/3231; H04N 1/00973

(57) ABSTRACT

According to examples, an apparatus may include a control panel and a control panel processor, which may detect a user input on the control panel while the apparatus is in a low-power state and may determine whether the detected user input corresponds to a user intent for a working component of the apparatus to be implemented. Based on a determination that the detected user input corresponds to a user intent for the working component to be implemented, the control panel processor may output a first signal to a device engine that causes the device engine to start up the working component. In addition, based on a determination that the detected user input does not correspond to a user intent for the working component to be implemented, the control panel processor may output a second signal that does not cause the device engine to start up the working component.

### BACKGROUND

Peripheral devices, such as scanners and/or printers, may include a control panel unit that controls a control panel screen. The peripheral devices may also include a main central processing unit (CPU) that may control the control panel unit. The peripheral devices often shift to a power saving mode under certain conditions to reduce power consumption. Under the power saving mode, the peripheral devices may stop power supply to the control panel unit and the CPU. In addition, the power supply may be stopped to working components, such as scanning components and/or printing components, in the peripheral devices. The peripheral devices may be returned from the power saving mode, for instance, through activation of a switch of the control panel unit. In response to returning from the power saving mode, the main CPU may perform startup processing of the working components such that the length of time between when the peripheral device is returned from the power saving mode to when the working components are ready for use may be minimized.

### BRIEF DESCRIPTION OF DRAWINGS

Features of the present disclosure are illustrated by way of example and not limited in the following figure(s), in which like numerals indicate like elements, in which:

FIG. 1 depicts a block diagram of an example apparatus that may output a first signal that causes a device engine to start up a working component of the apparatus or a second signal that does not cause the device engine to start up the working component based on a detected user input;

FIG. 2 shows a block diagram of another example apparatus that may include some of the same elements as the apparatus depicted in FIG. 1;

FIG. 3 shows a block diagram of another example apparatus that may output a first signal that causes a device engine to start up a working component of the apparatus or a second signal that does not cause the device engine to start up the working component based on a detected user input;

FIGS. 4 and 5, respectively, depict flow diagrams of example methods for outputting a device engine wake signal to a device engine to start up a working component of an apparatus based on a detected user intent with respect to the apparatus; and

FIG. 6 shows an example non-transitory machine-readable storage medium for outputting a device engine wake signal or a main engine wake signal based on a detected user intent with respect to an apparatus.

### DETAILED DESCRIPTION

For simplicity and illustrative purposes, the principles of the present disclosure are described by referring mainly to examples thereof. In the following description, numerous specific details are set forth in order to provide an understanding of the examples. It will be apparent, however, to one of ordinary skill in the art, that the examples may be practiced without limitation to these specific details. In some instances, well known methods and/or structures have not been described in detail so as not to unnecessarily obscure the description of the examples. Furthermore, the examples may be used together in various combinations.

Throughout the present disclosure, the terms “a” and “an” are intended to denote one of a particular element or multiple ones of the particular element. As used herein, the term “includes” means includes but not limited to, the term “including” means including but not limited to. The term “based on” may mean based in part on.

As discussed above, the main CPU of a peripheral device may perform startup processing of the working components in the peripheral device when the peripheral device is returned from a power saving mode. That is, the main CPU may perform the startup processing of the working components, e.g., a fuser, a lamp, a heater, a fan, and/or the like, whenever the peripheral device is returned from the power saving mode regardless of the reason for which the peripheral device was returned from the power saving mode. This may occur to minimize the length of time until the working components are available for use following recovery from the power saving mode, even when the working components are not implemented.

As a result, there may be instances in which the peripheral device is returned from the power saving mode in which the working component is not intended to be implemented. That is, for example, a user may return the peripheral device from the power saving mode to identify a network address of the peripheral device, to send an email stored on the peripheral device, or the like. In other words, a user may return the peripheral device from the power saving mode without the intention of scanning a document or printing a document. Accordingly, the working components may undergo the startup process from the power saving mode unnecessarily, which may cause additional wear on the working components. The additional wear may reduce the useful lives of the working components.

Disclosed herein are apparatuses and methods that may control a device engine to selectively start up a working component in an apparatus based upon a detected user intent with respect to the apparatus following recovery from a low-power mode. For instance, the apparatuses and methods disclosed herein may cause a control panel processor to, while the apparatus is in a low-power state or mode (which may be equivalent to a power saving state or mode, a standby state or mode, an idle state or mode, etc.), detect a user intent with respect to the apparatus. That is, the control panel processor may detect whether the user intends to print a document, scan a document, copy a document, or the like. In addition, or other alternatively, the control panel processor may detect whether the user does not intend for the apparatus to perform any of these actions, but instead, that the user intends for the apparatus to perform another action that does not include any of these actions.

Based on a determination that the user intends to implement the working component, e.g., intends to scan a document, print a document, copy a document, fax a document, or the like, the control panel processor may instruct the device engine to start up the working component. However, based on a determination that the user does not intend to implement the working component, the control panel processor may not instruct the device engine to start up the working component. Instead, the control panel processor may instruct the main processor of the apparatus to perform a startup process that does not include the starting up of the working component. For instance, the main processor may perform a startup process that enables execution of a requested action, e.g., output a network identifier of the apparatus, send an email, or the like.

Through implementation of the apparatuses and methods disclosed herein, the working component of an apparatus, which may perform printing and/or scanning operations, may selectively be started up following detection of a user input. That is, the working component may not be started up each time the apparatus recovers or returns from a low-power state. Instead, the working component may be started up based on a determination that a user intends for the working component to be implemented. As a result, the number of times that the working component may be started up may be smaller than the number of times that the apparatus in which the working component is housed is started up following being in a low-power state. In one regard, therefore, a useful life of the working component may be extended while also enabling the working component to be ready for use in a minimized length of time following detection of a user intent for the working component to be implemented.

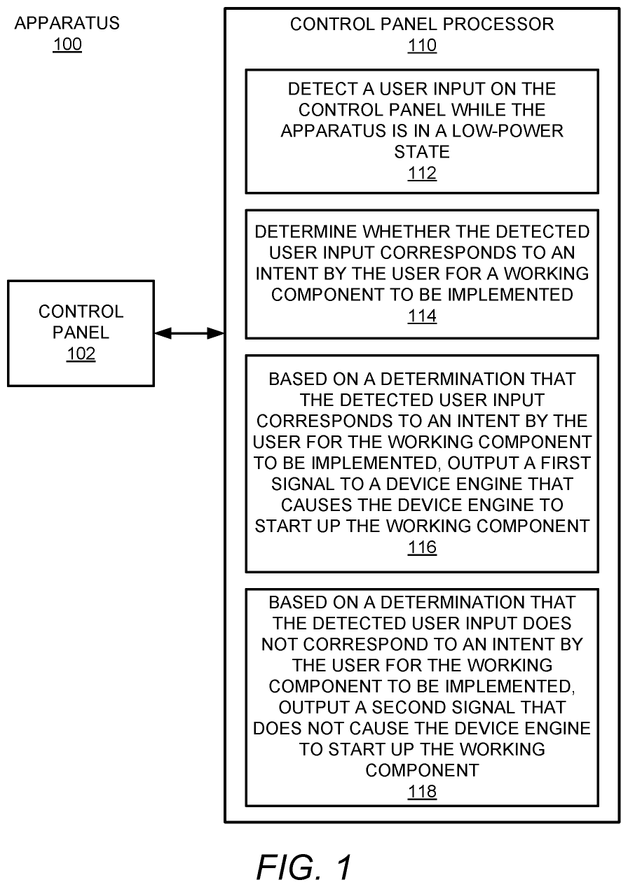

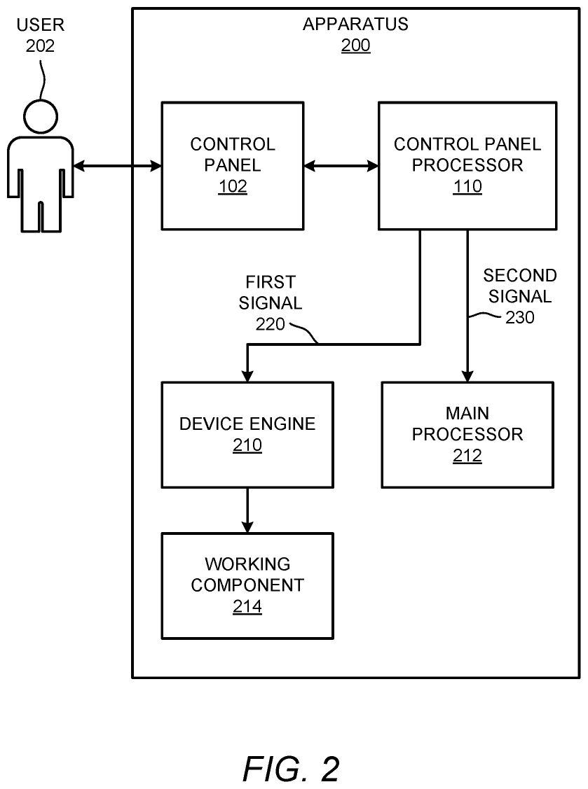

Reference is first made to FIGS. 1 and 2. FIG. 1 shows a block diagram of an example apparatus 100 that may output a first signal that causes a device engine to start up a working component of the apparatus or a second signal that does not cause the device engine to start up the working component based on a detected user input. FIG. 2 shows a block diagram of another example apparatus 200 that may include some of the same elements as the apparatus 100 depicted in FIG. 1. It should be understood that the example apparatus 100 depicted in FIG. 1 and/or the example apparatus 200 depicted in FIG. 2 may include additional features and that some of the features described herein may be removed and/or modified without departing from the scopes of the apparatuses 100, 200.

According to examples, the apparatuses 100, 200 depicted in FIGS. 1 and 2 may each be a peripheral device, such as a multifunction device, a printer, a scanner, or the like. In addition, each of the apparatuses 100, 200 may include a control panel 102 through which a user 202 may interface with the apparatuses 100, 200. The control panel 102 may include a display on which various information may be displayed. The various information may include icons representing various actions that the user 202 may select, such as a copy function, a scanning function, an emailing function, a settings function, and/or the like. In these examples, the control panel 102 may include a touch-sensitive display, such as a touch-capacitive screen. In addition, or in other examples, the control panel 102 may include physical buttons that may be linked to various actions that the user 202 may select.

In any of the examples discussed above, a control panel processor 110 may control the control panel 102. That is, the control panel processor 110 may detect user 202 interactions with the control panel 102 and may perform various actions based on the detected interactions. The control panel processor 110 may be a semiconductor-based microprocessor, a central processing unit (CPU), an application specific integrated circuit (ASIC), a field-programmable gate array (FPGA), and/or other suitable hardware device. Although the apparatuses 100, 200 have been depicted as each including a single control panel processor 110, the apparatuses 100, 200 may each include multiple control panel processors 110 without departing from scopes of the apparatuses 100, 200.

As shown in FIG. 2, the apparatus 200 may also include a device engine 210 and a main processor 212. The device engine 210 and/or the main processor 212 may also be a semiconductor-based microprocessor, a central processing unit (CPU), an application specific integrated circuit (ASIC), a field-programmable gate array (FPGA), and/or other suitable hardware device. In any regard, the device engine 210 may control a working component 214, which may be a printing component, a scanning component, or the like. The printing component may be a fuser, a heating element, a fan, a motor, and/or the like, and the scanning component may be a lamp, a fan, a motor, and/or the like. The main processor 212 may control other components in the apparatus 200, e.g., may supply information to be displayed on the control panel 102, may access information to be scanned/printed, may control emailing of documents, etc.

According to examples, the control panel processor 110 may detect 112 a user input on the control panel 102 while the apparatus 100, 200 is in a low-power state. That is, for instance, the control panel processor 110 may detect the user input while the apparatus 100, 200 is in a power saving mode, such as a standby mode, an idle mode, etc. While in the low-power state, the control panel 102 and the control panel processor 110 may draw a low amount of power such that the control panel processor 110 may detect a user input on the control panel 102. In addition, while in the low-power state, the working component 214 may be turned off or may otherwise be in an inactive or idle state. As discussed herein, the working component 214 may not be ready to be implemented immediately following being started from the inactive state. Instead, after returning from the low-power state, the working component 214 may undergo a warmup period after being started up and prior to being ready to be implemented during a printing and/or a scanning operation.

The control panel processor 110 may detect the user input on the control panel 102 as at least one of a user 202 contact on a control panel display, a near contact by the user on the control panel display, a movement on the control panel display following contact by the user on the control panel display, and/or the like. The near contact by the user 202 may include a detection of the user 202 near, e.g., within a certain distance, of the control panel display prior to contact by the user 202 of the control panel display. The control panel display may include, for instance, a touch-capacitive screen that may detect the presence of a user's finger or input device (e.g., pen) prior to actual contact with the control panel display.

The control panel processor 110 may also determine 114 whether the detected user input corresponds to an intent by the user 202 for the working component 214 to be implemented. For instance, the control panel processor 110 may identify a location of the detected user input on the control panel 102. In addition, to determine whether the detected user input corresponds to an intent by the user for the working component 214 to be implemented, the control panel processor 110 may determine that the detected user input corresponds to a user intent for the working component 214 to be implemented based on the identified location being within a predefined area of the control panel 102.

By way of example, the control panel processor 110 may identify a particular area on a control panel 102, e.g., a particular set of x-y coordinates, a particular icon, a particular button on a keypad, or the like, as corresponding to an intent by the user 202 for the working component 214 to be implemented. The particular area/button may be, for instance, an icon/button corresponding to a scanning operation, a copying operation, a printing operation, and/or the like.

The control panel processor 110 may output one of a first signal 220 and a second signal 230 based on the identified location on the control panel 102 at which the user input is detected to have occurred. That is, based on a determination that the detected user input corresponds to a user intent for the working component 214 to be implemented, the control panel processor 110 may output 116 a first signal 220 to the device engine 210. The output of the first signal 220 to the device engine 210 may cause the device engine 210 to start up the working component 214. In other words, based on a determination that user 202 has intended to print, scan, copy, etc., a document based on the detected user input, the control panel processor 110 may directly output the first signal 220 to the device engine 210 to begin a warmup operation of the working component 214.

In some examples, the control panel processor 110 may output the first signal 220 to the device engine 210 without first storing the first signal 220 in a memory or other data storage location. In these examples, the working component 214 may be brought to a working state in a relatively shorter period of time than if the warmup of the working component 214 were started following other operations in the apparatus 100, 200. In addition, the device engine 210 may, based on receipt of the first signal 220, send a signal to the main processor 212 to inform the main processor 212 of the state of the device engine 210. In other examples, the control panel processor 110 may output the first signal 220 to both the device engine 210 and the main processor 212. In addition, or alternatively, the working component 214 may not be directly connected to the device engine 210, but may instead be connected to the main processor 212. In these examples, the device engine 210 may cause the device engine 210 to start up the working component 214 via the main processor 212.

However, based on a determination that the detected user input does not correspond to a user intent for the working component 214 to be implemented, the control panel processor 110 may output 118 a second signal 230 that does not cause the device engine 210 to start up the working component 214. That is, for instance, based on a determination that the detected user input did not occur within the predefined area of the control panel 102, the control panel processor 110 may output the second signal 230 to the main processor 212. In response to receipt of the second signal 230, the main processor 212 may begin startup of components in the apparatus 100, 200 other than the working component 214. For instance, the main processor 212 may access a memory of the apparatus 100, 200 and may execute instructions corresponding to the detected user input.

According to examples, the operations 112-118 may be machine readable instructions stored on a memory (not shown) that the control panel processor 110 may execute. The memory may be an electronic, magnetic, optical, or other physical storage device that contains or stores executable instructions. The memory may be, for example, Random Access memory (RAM), an Electrically Erasable Programmable Read-Only Memory (EEPROM), a storage device, an optical disc, and the like. The memory may also be referred to as a non-transitory machine-readable storage medium, where the term “non-transitory” does not encompass transitory propagating signals.

In addition or in other examples, the operations 112-118 may be stored in hardware logic blocks. In other examples, the apparatus 100 may include a combination of instructions and hardware logic blocks to implement or execute functions corresponding to the operations 112-118. In any of these examples, the control panel processor 110 may implement the hardware logic blocks and/or execute the operations 112-118. As discussed herein, the apparatus 100 may also include additional instructions and/or hardware logic blocks such that the control panel processor 110 may execute operations in addition to or in place of those discussed above with respect to FIG. 1.

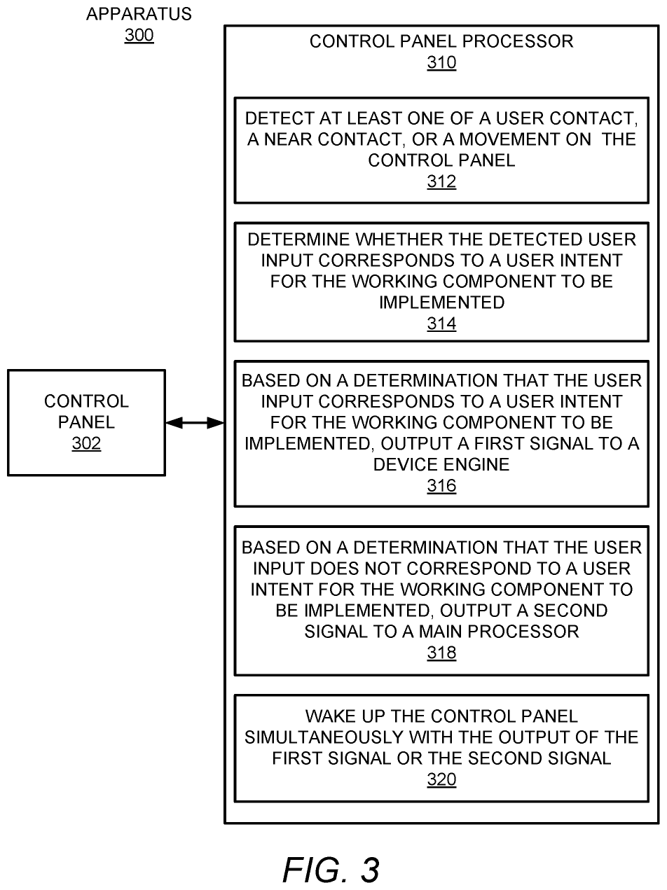

Reference is now made to FIG. 3, which shows a block diagram of another example apparatus 300 that may output a first signal 220 that causes a device engine 210 to start up a working component 214 of the apparatus 100, 200 or a second signal 230 that does not cause the device engine 210 to start up the working component 214 based on a detected user input. It should be understood that the example apparatus 300 depicted in FIG. 3 may include additional features and that some of the features described herein may be removed and/or modified without departing from the scope of the apparatus 300. The description of the apparatus 300 is also made with reference to FIGS. 1 and 2.

According to examples, the apparatus 300 may be equivalent to the apparatuses 100, 200 depicted in FIGS. 1 and 2. As shown in FIG. 3, the apparatus 300 may include a control panel 302 and a control panel processor 310. The control panel processor 310 may be similar to the control panel processor 110 and may perform operations 312-320. The operations 312-320 may be machine-readable instructions stored on a memory that the control panel processor 310 may execute and/or may be stored in hardware logic blocks that the control panel processor 310 may implement.

As shown, the control panel processor 310 may detect 312 a user input as at least one of the user contact, a near contact, a movement on the control panel display following contact by the user on the control panel display, and/or the like. The near contact by the user 202 may include a detection of the user 202 near, e.g., within a predefined distance, of the control panel display prior to contact by the user 202 of the control panel display. In addition, the control panel processor 310 may detect the user input while the apparatus 300 is in a low-power state.

The control panel processor 310 may determine 314 whether the detected user input corresponds to a user intent for the working component 214 to be implemented. That is, for instance, the control panel processor 310 may determine, based on the detected user input, whether the user intends to print, scan, copy, or the like, a document.

Based on a determination that the user input corresponds to a user intent for the working component 214 to be implemented, the control panel processor 310 may output 316 a first signal 220 to the device engine 210. Receipt by the device engine 210 of the first signal 220 may cause the device engine 210 to start up the working component 214. In addition, the control panel processor 110 may output the first signal 220 to the device engine 210 directly, e.g., without first storing the first signal 220 in a memory. The control panel processor 110 may alternatively output the first signal 220 to both the device engine 210 and the main processor 212 concurrently.

However, based on a determination that the user input does not correspond to a user intent for the working component 214 to be implemented, the control panel processor 310 may output 318 a second signal 230 to the main processor 212.

In addition, simultaneously with, immediately prior to, or immediately after outputting the first signal 220 or the second signal 230, the control panel processor 110 may wake up 320 the control panel 102. That is, the control panel processor 110 may cause the control panel 102 to return from the low-power state following detection of being user input on the control panel 102. Upon waking up, the control panel 102 may be ready to receive additional instructions from the user 202.

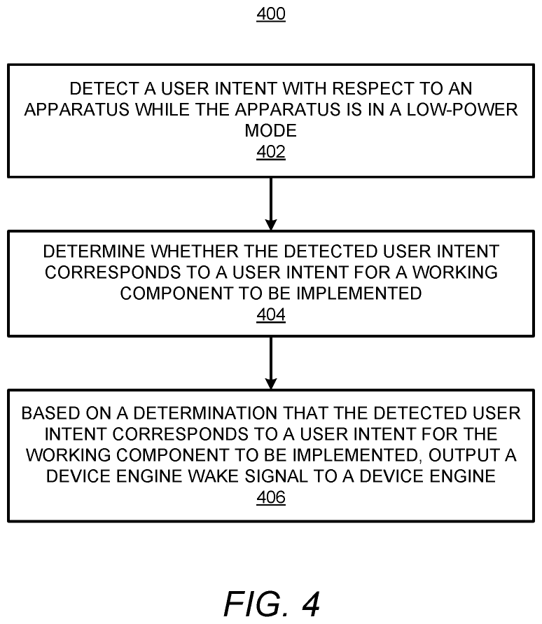

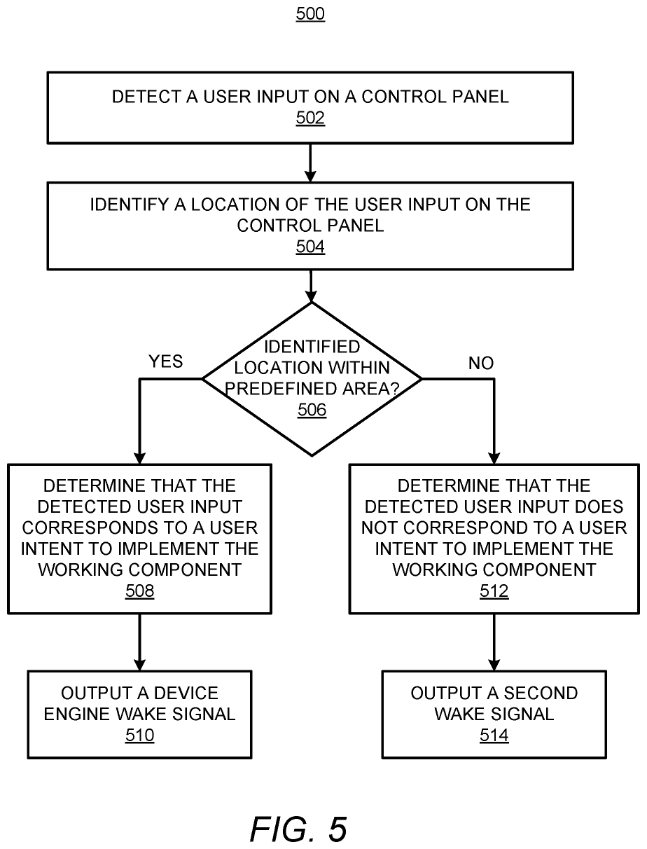

Various manners in which the control panel processor 110, 310 may operate are discussed in greater detail with respect to the methods 400 and 500 depicted in FIGS. 4 and 5. Particularly, FIGS. 4 and 5, respectively, depict flow diagrams of example methods 400 and 500 for outputting a device engine wake signal to a device engine to start up a working component of an apparatus 100-300 based on a detected user intent with respect to the apparatus 100-300. It should be understood that the methods 400 and 500 respectively depicted in FIGS. 4 and 5 may include additional operations and that some of the operations described therein may be removed and/or modified without departing from the scopes of the methods 400 and 500. The descriptions of the methods 400 and 500 are made with reference to the features depicted in FIGS. 1-3 for purposes of illustration.

With reference first to FIG. 4, at block 402, the control panel processor 110, 310 may detect a user intent with respect to an apparatus 100-300 while the apparatus 100-300 is in a low-power mode. The control panel processor 110, 310 may detect the user intent and any of the manners discussed above.

In addition, or in other examples, the control panel processor 110, 310 may detect the user intent in other manners. For instance, the control panel processor 110 may determine that the user 202 has interacted with the control panel and may determine, from historical data, whether the user interaction corresponds to an intent by the user for the working component 214 to be implemented. That is, the control panel processor 110 may track the user 202 interactions with the apparatus 100, 300 and may store information pertaining to the user 202 such as, interactions that resulted in the user 202 implementing the working component 214 and interactions that resulted in the user 202 not implementing the working component 214. The control panel processor 110 may also track other information, such as the dates and times at which the user 202 either implemented or did not implement the working component 214.

As another example, the control panel processor 310 may detect receipt of an instruction from a user mobile device to interact with the apparatus 100-300. That is, for instance, the user 202 may input an instruction through the user mobile device, which may be smartphone, a laptop computer, a tablet computer, or the like, to interact with the apparatus 100-300. The user 202 may input the instruction via an application or via another manner.

At block 404, the control panel processor 110, 310 may determine whether the detected user intent corresponds to a user intent for a working component 214 in the apparatus 100-300 to be implemented. In addition to the manners discussed herein, the control panel processor 110, 310 may make this determination in other manners. For instance, the control panel processor 110, 310 may determine that the detected user intent corresponds to a user intent for the working component 214 to be implemented based on the historical data indicating that the detected user intent corresponds to an intent for the working component 214 to be implemented. As another examples, the control panel processor 110, 310 may determine that the detected user intent corresponds to a user intent for the working component 214 to be implemented based on receipt of the instruction to print, scan, copy, or the like, from the user device.

At block 406, based on a determination that the detected user intent corresponds to a user intent for the working component 214 to be implemented, the control panel processor 110, 310 may output a device engine wake signal (which may be equivalent to the first signal 220) to a device engine 210 of the apparatus 100-300 that causes the device engine 210 to start up the working component 214. As also discussed herein, based on a determination that the detected user intent does not correspond to a user intent for the working component 214 to be implemented, the control panel processor 110, 310 may output a second signal 230 to the main processor 212 to wake up components of the apparatus 100-300 other than the working component 214.

Turning now to FIG. 5, at block 502, the control panel processor 110, 310 may detect a user input on a control panel 102, 302 while the apparatus 100-300 is in a low-power state. In addition, at block 504, the control panel processor 110 may identify a location of the user input on the control panel 102, 302. That is, for instance, the control panel processor 110, 310 may determine the X-Y coordinates on a control panel display at which a user 202 has contacted or nearly contacted. As another example, the control panel processor 110, 310 may determine which button of a number of buttons on a keypad has been depressed.

At block 506, the control panel processor 110, 310 may determine whether the identified location is within a predefined area. The control panel processor 110, 310 may have been programmed or otherwise instructed to identify the predefined area on the control panel 102, 302, e.g., a particular icon on a display, a particular button on a keypad, or the like, as corresponding to an intent by the user 202 for the working component 214 to be implemented. The particular area/button may be, for instance, an icon/button corresponding to a scanning operation, a copying operation, a printing operation, and/or the like.

Based on a determination that the identified location is within the predefined area at block 506, the control panel processor 110, 310 may determine that the detected user input corresponds to a user intent to implement the working component 214 as indicated at block 508. In addition, at block 510, the control panel processor 110, 310 may output a device engine wake signal 220 to the device engine 210 to cause the device engine 210 to start up the working component 214.

However, based on a determination that the identified location is outside of the predefined area at block 506, the control panel processor 110, 310 may determine that the detected user input does not correspond to a user intent to implement the working component 214 as indicated at block 512. In addition, at block 512, the control panel processor 110, 310 may output a second signal 230 to the main processor 212 to cause the main processor 212 to start up other components in the apparatus 100-300 other than the working component 214.

Some or all of the operations set forth in the methods 400 and 500 may be included as utilities, programs, or subprograms, in any desired computer accessible medium. In addition, the methods 400 and 500 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

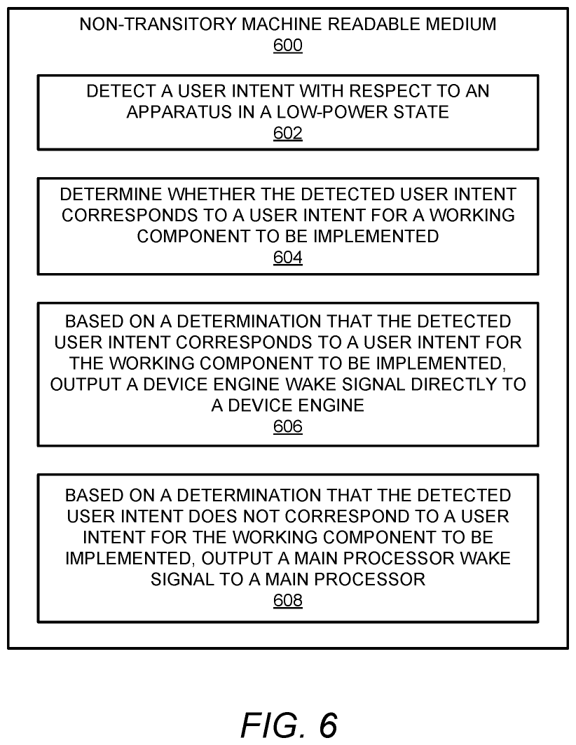

Turning now to FIG. 6, there is shown an example non-transitory machine-readable storage medium 600 for outputting a device engine wake signal 220 or a main engine wake signal 230 based on a detected user intent with respect to an apparatus 100-300. The machine-readable storage medium 600 may be an electronic, magnetic, optical, or other physical storage device that contains or stores executable instructions. The machine-readable storage medium 600 may be, for example, Random Access memory (RAM), an Electrically Erasable Programmable Read-Only Memory (EEPROM), a storage device, an optical disc, and the like.

The non-transitory machine-readable storage medium 600 may have stored thereon machine readable instructions 602-608 that a control panel processor, e.g., the control panel processor 110, 310 may execute. The machine readable instructions 602 may cause the control panel processor 110, 310 to detect a user intent with respect to the apparatus 100-300 while the apparatus 100-300 is in a low-power state. According to examples, the control panel processor 110, 310 may detect the user intent through detection of a user input on a control panel 102, 302 of the apparatus 100-300, in which the user input includes at least one of a contact by the user on the control panel 102, 302, a near contact by the user on the control panel 102, 302, or a movement across the control panel 102, 302 following contact by the user on the control panel 102, 302.

The machine readable instructions 604 may cause the control panel processor 110, 310 to determine whether the detected user intent corresponds to a user intent for a working component 214 in the apparatus 100-300 to be implemented. Based on a determination that the detected user intent corresponds to a user intent for the working component 214 to be implemented, the machine readable instructions 606 may cause the control panel processor 110, 310 to output a device engine wake signal 220 directly to a device engine 210 of the apparatus 100-300. The device engine wake signal 220, which may be equivalent to the first signal 220, may cause the device engine 210 to start up the working component 214. In addition, based on a determination that the detected user intent does not correspond to a user intent for the working component 214 to be implemented, the machine readable instructions 606 may cause the control panel processor 110, 310 to output a main processor wake signal 230 to a main processor 212. The main processor wake signal 230, which may be equivalent to the second signal 230, may not cause the device engine 210 to start up the working component 214.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a control panel; and
a control panel processor to:
detect a user input on the control panel while the apparatus is in a low-power state;
determine whether the detected user input corresponds to an intent by the user for a working component of the apparatus to be implemented;
based on a determination that the detected user input corresponds to a user intent for the working component to be implemented, output a first signal to a device engine that causes the device engine to start up the working component; and
based on a determination that the detected user input does not correspond to a user intent for the working component to be implemented, output a second signal that does not cause the device engine to start up the working component.

2. The apparatus of claim 1, wherein, to detect the user input, the control panel processor is to identify a location of the detected user input on the control panel, and wherein to determine whether the detected user input corresponds to an intent by the user for the working component to be implemented, the control panel processor is to determine that the detected user input corresponds to a user intent for the working component to be implemented based on the identified location being within a predefined area of the control panel.

3. The apparatus of claim 1, wherein the control panel processor is further to directly send the first signal to the device engine based on the determination that the detected user input corresponds to a user intent for the working component to be implemented.

4. The apparatus of claim 1, wherein the control panel includes a control panel display and wherein the control panel processor is to detect the user input on the control panel display as at least one of a user contact on the control panel display, a near contact by the user on the control panel display, or a movement on the control panel display following contact by the user on the control panel display.

5. The apparatus of claim 1, further comprising:
a main processor; and
wherein the control panel processor is to one of:
output the first signal to the device engine without sending the first signal to the main processor; or
output the first signal to both the device engine and the main processor.

6. The apparatus of claim 1, wherein the control panel comprises a keypad and wherein the control panel processor is to detect the user input on the keypad.

7. The apparatus of claim 1, wherein the control panel processor is further to wake the control panel simultaneously with the output of the first signal or the second signal.

8. A method comprising:
detecting, by a control panel processor, a user intent with respect to an apparatus while the apparatus is in a low-power mode;
determining, by the control panel processor, whether the detected user intent corresponds to a user intent for a working component in the apparatus to be implemented; and
based on a determination that the detected user intent corresponds to a user intent for the working component to be implemented, outputting, by the control panel processor, a device engine wake signal to a device engine of the apparatus that causes the device engine to start up the working component.

9. The method of claim 8, wherein, detecting the user intent further comprises detecting a user input on a control panel of the apparatus and identifying a location of the user input on the control panel, and wherein determining whether the detected user intent corresponds to a user intent for the working component to be implemented further comprises determining that the detected user input corresponds to a user intent for the working component to be implemented based on the identified location being within a predefined area of the control panel.

10. The method of claim 9, further comprising:
determining that the identified location is outside of the predefined area of the control panel; and
based on the determination that the identified location is outside of the predefined area of the control panel, outputting a second signal that does not cause the device engine to start up the working component.

11. The method of claim 8, wherein detecting the user intent further comprises detecting a user input on a control panel of the apparatus, wherein the user input comprises at least one of a contact by the user on the control panel, a near contact by the user on the control panel, or a movement on the control panel following contact by the user on the control panel.

12. The method of claim 8, wherein detecting the user intent further comprises determining that the user has interacted with the control panel and determining, from historical data, whether the user interaction corresponds to an intent by the user for the working component to be implemented.

13. The method of claim 8, wherein detecting the user intent further comprises detecting receipt of an instruction from a user mobile device to interact with the apparatus and wherein determining whether the detected user intent corresponds to a user intent for the working component to be implemented further comprises determining, based on the received instruction, that the detected user intent corresponds to a user intent for the working component to be implemented.

14. A non-transitory computer readable medium on which is stored machine readable instructions that when executed by a control panel processor, cause the control panel processor to:
detect a user intent with respect to an apparatus while the apparatus is in a low-power state;
determine whether the detected user intent corresponds to a user intent for a working component in the apparatus to be implemented;
based on a determination that the detected user intent corresponds to a user intent for the working component to be implemented, output a device engine wake signal directly to a device engine of the apparatus, wherein the device engine wake signal causes the device engine to start up the working component; and
based on a determination that the detected user intent does not correspond to a user intent for the working component to be implemented, output a main processor wake signal to a main processor, wherein the main processor wake signal does not cause the device engine to start up the working component.

15. The non-transitory computer readable medium of claim 14, wherein to detect the user intent, the instructions are further to cause the control panel processor to:
detect a user input on a control panel of the apparatus, wherein the user input comprises at least one of a contact by the user on the control panel, a near contact by the user on the control panel, or a movement across the control panel following contact by the user on the control panel.
